(19) United States
(12) Patent Application Publication
(10) Pub. No.: US 2007/0281499 A1
(43) Pub. Date: Dec. 6, 2007

(54) Printed wiring board, its bending method, and electronic apparatus

(76) Inventors: Kiyomi Muro, Hachioji-shi (JP); Jun Karasawa, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/807,580

(22) Filed: May 29, 2007

(30) Foreign Application Priority Data
May 30, 2006 (JP) 2006-150031

(51) Int. Cl. H01R 39/00

(52) U.S. Cl. 439/26

(57) ABSTRACT

According to one embodiment, a printed wiring board includes a first layer which has a plurality of grooves disposed in a bent area, and each length direction of the plurality of grooves intersects to a bending direction, and a second layer which is disposed on a face of a side opposed to a face with the grooves of the first layer disposed thereon.

### CROSS-REFERENCE TO RELATED APPLICATIONS

This application is based upon and claims the benefit of priority from Japanese Patent Application No. 2006-150031, filed May 30, 2006, the entire contents of which are incorporated herein by reference.

### BACKGROUND

1. Field

One embodiment of the invention relates to a printed wiring board which gives a bending property at a part thereof, its manufacturing method, and electronic apparatus.

2. Description of the Related Art

As to a technique which gives a bending property at a part of a rigid printed wiring board, a technique, which forms a bent area in a partial area of a multi-layered board in a laminating process, and a technique which gives a bending property in a part of an area of the multi-layered wiring board through a cutting process, have been presented.

Among of them, the technique which forms the bent area in the partial area of the multi-layer wiring board in the laminating process (Jpn. Pat. Appln. KOKAI Publication No. 8-125342) providing a wiring structure of a partially laminated structure which forms an area decreased in thickness of a single insulating layer among a multi-layered wiring board (area increased in thickness), the technique needs a specific manufacturing technique. On the other hand, the technique which gives the bent property in the partial area of the multi-layered wiring board through the cutting process may easily form the bent area in the partial area of the multi-layer wiring board by cutting and thinning the partial area thereof through an existing technique.

The technique which gives the bent property in the partial area of the multi-layered wiring board through the cutting process has the problem on a yield ratio such that when the technique shaves off the area of a part to which it intends to give the bending property by a cutting technique such as a router and a laser process except at least one insulating layer, a cutting surface is made uneven, and stress in bending is concentrated to a depression to result in a breakage of a bent part. The technique has to shave off the entire area to be given the bent property so as to make a flat face as much as possible, so that it has taken a long time to perform cutting work.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting a structure of a printed wiring board according to a first embodiment of the present invention;

FIG. 2 is an exemplary view depicting a shape of a groove applicable to each embodiment of the invention;

FIG. 3 is another exemplary view depicting a shape of a groove applicable to each embodiment of the invention;

FIG. 4 is another exemplary view depicting a shape of a groove applicable to each embodiment of the invention;

FIG. 5 is another exemplary view depicting a shape of a groove applicable to each embodiment of the invention;

FIG. 6A and FIG. 6B are exemplary views depicting bending process examples of printed wiring boards according to a first embodiment of the invention;

FIG. 7A and FIG. 7B are exemplary views depicting bending process examples of printed wiring boards according to a first embodiment of the invention;

FIG. 8A and FIG. 8B are exemplary views depicting bending process examples of printed wiring boards according to a second embodiment of the invention;

FIG. 9 is an exemplary view depicting a bending process example of a printed wiring board according to the second embodiment;

FIG. 10 is an exemplary view depicting a bending process example of a printed wiring board according to a third embodiment of the invention;

FIG. 11 is another exemplary view depicting a bending process example of a printed wiring board according to the third embodiment;

FIG. 12 is another exemplary view depicting a bending process example of a printed wiring board according to the third embodiment;

FIG. 13 is an exemplary view depicting a bending process example of a printed wiring board according to a fourth embodiment of the invention; and

FIG. 14 is an exemplary view depicting a structure of electronic apparatus according to embodiments of the invention.

### DETAILED DESCRIPTION

Various embodiments according to the invention will be described hereinafter with reference to the accompanying drawings. In general, according to one embodiment of the invention, a printed wiring board comprises a first layer which has a plurality of grooves disposed in a bent area, and each length direction of the plurality of grooves intersects to a bending direction, and a second layer which is disposed on a face of a side opposed to a face with the grooves of the first layer disposed thereon.

Hereinafter, embodiments of the present invention will be described with reference to the drawings.

### First Embodiment

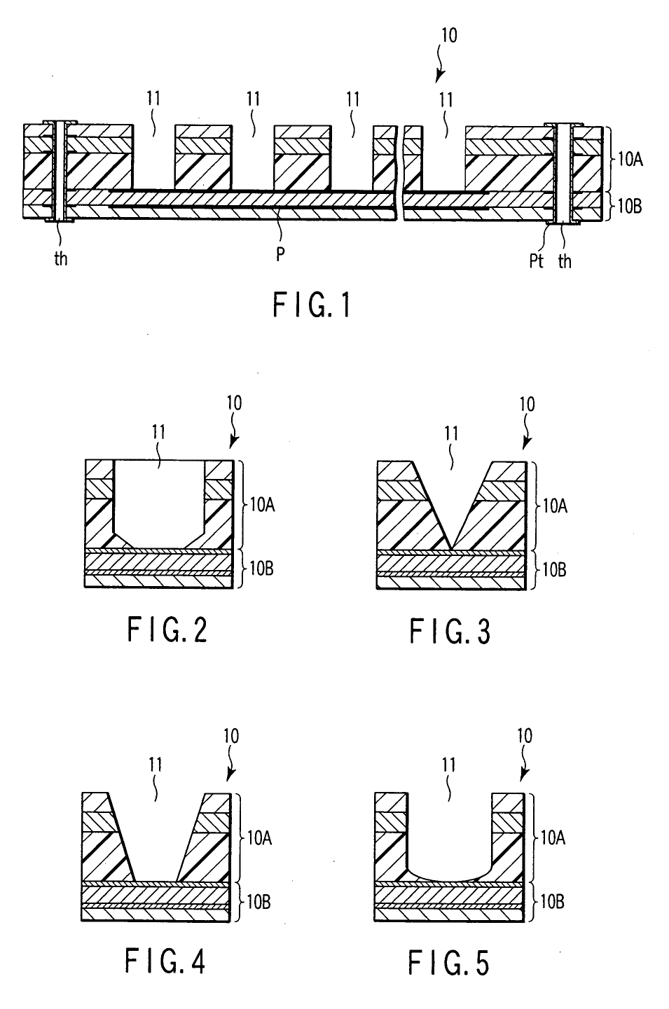

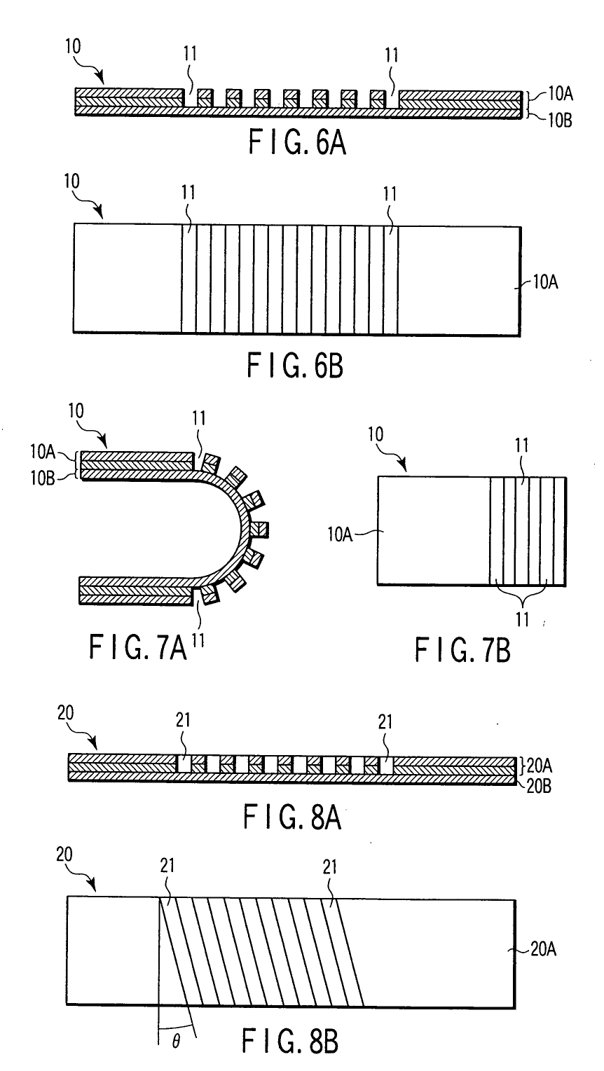

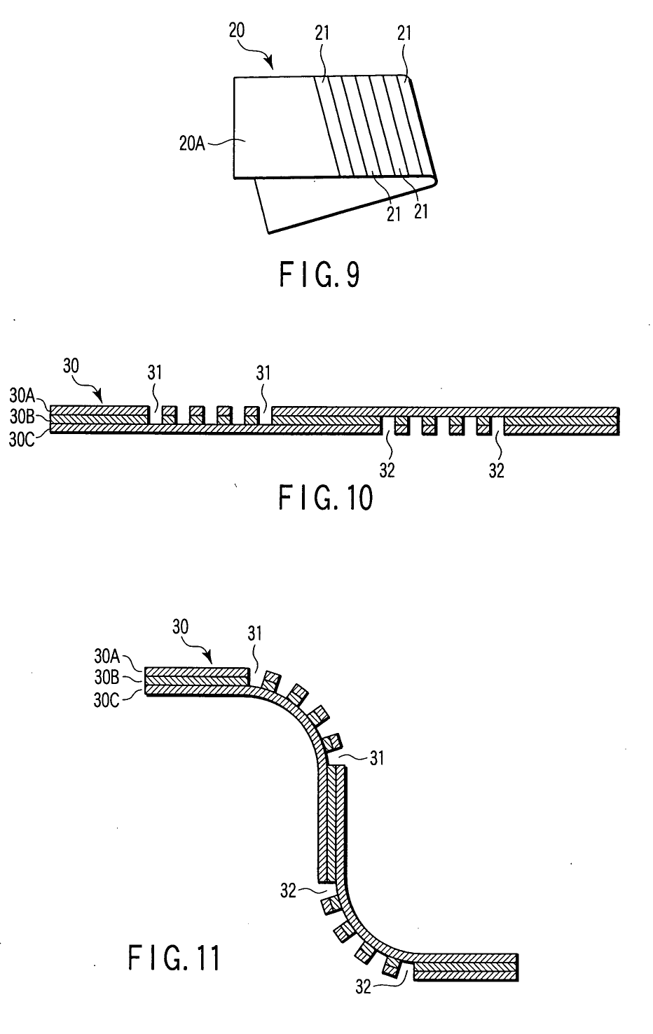

FIG. 1 illustrates a structure of a printed wiring board according to a first embodiment of the invention.

A printed wiring board 10 according to the first embodiment of the invention shown in FIG. 1 includes a first layer 10A and a second layer 10B layered with each other. The first layer 10A and the second layer 10B are structured to have an insulating layer of one layer or a plurality of layers formed of prepreg materials, respectively, and conductive layers formed on one face, or on both faces of the insulating layer. A through plug Pt to circuit-connect between the first layer 10A and the second layer 10B is formed in the first and the second layers 10A and 10B. A wiring pattern P striding across a bending part is formed in at least one conductive layer in the second layer 20.

A plurality of grooves 11, 11, . . . , are disposed in the first layer 10A in an area, which is required to be bent, of the printed wiring board 10. Length directions of the plurality of grooves 11, 11, . . . , are set so as to intersect with a bending direction. In the case of the first embodiment, the length directions of the plurality of grooves 11, 11, . . . , are almost orthogonal to the bending direction.

Widths and pitches of the plurality of grooves 11, 11, . . . , are decided on the basis of a variety of conditions, such as directions and angles to be bent, circular arc diameters, and thickness and hardness of each layer.

Each grooves 11, 11, . . . , are cut by a router or a laser process. FIGS. 2 to 5 illustrate various types of shaves of the grooves 11 applicable to this embodiment. The cross sections of the respective grooves 11, 11, . . . , are formed in a U- or V-shape. FIGS. 2 to 5 illustrate examples of the grooves which are cut in a U-shape and FIGS. 3 and 4 depict examples of the grooves cut in a V-shape.

As shown in FIG. 1, the printed wiring board 1 disposes a plurality of grooves, 11, 11, . . . , in the area to be bent, and forms the bent area by the grooves 11, 11, . . . , so that it realizes a printed wiring board having a bending property at a part thereof.

The printed wiring board 10 shown in FIG. 1 may distribute the stress in bending into a plurality of bent parts formed by grooves 11, 11, . . . , thereby, it may eliminate the problem on the yield ratio such that excessive stress in bending concentrates to part of the bent part to result in a breakage thereof. Further, partially cutting the area to be bent by the plurality of grooves 11, 11, . . . , may shorten the time to be taken for cutting work.

FIGS. 6A and 6B, and FIGS. 7A and 7B depict bending process examples of the printed wiring boards according to the first embodiment. In FIGS. 6A and 6B, and FIGS. 7A and 7B, FIGS. 6A and 7A are side views, and FIGS. 6B and 7B are plane views.

In the bending process examples of the printed wiring board according to the first embodiment are, as shown in FIGS. 6A and 6B, the area to be bent of the printed wiring board 10 including the laminated first layer 10A and the second layer 10B is applied the cutting process at widths and pitches preset by the foregoing conditions so as to make each groove 11, 11, . . . , parallel to each other. In the first embodiment, the cutting process by the router forms a plurality of grooves 11, 11, . . . , each shaped in U letter shown in FIG. 2 in the first layer 10A in parallel with one another.

As shown in FIGS. 7A and 7B, the printed wiring board 10 is bent so that the grooves 11, 11, . . . , are disposed on the outer side of the bending after the grooves 11, 11, . . . , on the printed wiring board 10.

Thereby, the bending process may distribute the stress in bending into the plurality of bend parts formed by the grooves 11, 11, . . . , and may bent the printed wiring board 10 in a U-shape, as shown in FIG. 7A, without posing a defect such that the excess stress in bending concentrates to part of the bent part to result in breakage thereof.

### Second Embodiment

FIGS. 8A, 8B and 9 illustrate bending process examples of printed wiring boards according to a second embodiment of the invention. FIG. 8A is a side view, and FIG. 8B is a plane view. The second embodiment is featured in that length directions of a plurality of grooves are formed in parallel with one another and inclined to the bending direction.

The bending and fabricating example of the printed wiring board according to the second embodiment makes, as shown in FIGS. 8A and 8B, an angle in the folding direction in the bent area in the area to be bent of a printed wiring board 20 including the layered first layer 20A and second layer 20B, and applies a cutting process to the area to be bent of the printed wiring board 20 so as to make each groove of a plurality of grooves 21, 21, . . . , parallel to one another. Each angle between each length direction and the bending direction of the plurality of grooves 21, 21, . . . , are prescribed and inclined angle θ.

After forming the grooves 21, 21, . . . , onto the printed wiring board 20, the bending process bends, as depicted in FIG. 9, the printed wiring board 20 so that the grooves 21, 21, . . . , are disposed on the outer side of the bending.

Thereby, the bending process may distribute the stress in bending into a plurality of bent parts formed by the grooves 21, 21, . . . , and may bend the printed wiring board 20 in a U-shape in a state in which the printed wiring board 20 is inclined at a prescribed angle to the bending direction in the first embodiment without causing a defect such that the excess stress in bending concentrates to a part of the bent part to result in a breakage thereof.

### Third Embodiment

FIGS. 10 to 12 depict bending process examples of printed wiring boards according to a third example of the present invention. The third embodiment is characterized by disposing an intermediate layer between a first layer and a second layer, and by disposing grooves reaching the intermediate layer in different areas in each first and second layer, respectively.

The bending process example of the printed wiring board according to the third embodiment is, as shown in FIG. 10, cuts and facilitates a plurality of grooves 31, 31, . . . , 32, 32, . . . , at widths and pitches prescribed by the forgoing conditions in areas to be bent of a printed wiring board 30 including layered first layer 30A, second layer 30B, and third layer 30C so as to make each groove 31, 31, . . . , 32, 32, . . . , parallel to one another. In the third embodiment, the bending process forms a plurality of grooves in different wiring board positions (areas to be bent) of the first layer 30A and the third layer 30C forming surface layers, respectively, through the second layer 30B as an intermediate layer (inner layer). The bending process forms the grooves 31, 31, . . . , in the first layer 30A, and forms the grooves 32, 32, . . . , in the third layer 30C.

After forming each groove 31, 31, . . . , 32, 32, . . . , in each area to be bent of the printed wiring board 30, respectively, the bending process bends the printed wiring board 30 so that the groves 31, 31, . . . , 32, 32, . . . are disposed on the outside of the bending, as depicted in FIG. 11.

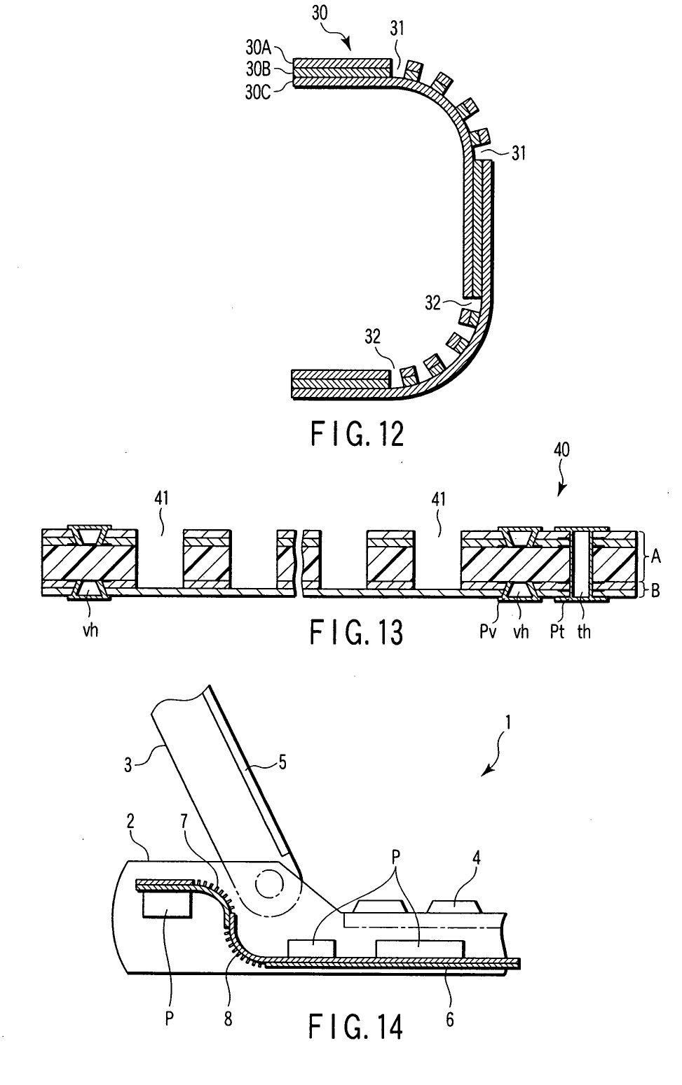

Or, as illustrated in FIG. 12, the bending process bends the printed wiring board 30 so that the grooves 31, 31, . . . , are arranged outside of the bending, and so that the grooves 32, 32, . . . , are arranged inside of the bending.

Thereby, the bending process may distribute the stress in bending into a plurality of bent parts formed by the groves 31, 31, . . . , 32, 32, . . . , and may bend the printed wiring board 30 so that the grooves 31, 31, . . . , 32, 32, . . . , disposed the inside or outside of the bending without causing a defect such that the excess stress in bending concentrates to part of the bent part to break the bent part.

### Fourth Embodiment

FIG. 13 illustrates a bending process example of a printed wiring board according to a fourth embodiment of the invention.

A printed wiring board 40 according to a fourth embodiment includes an A layer and a B layer, and forms the B layer by a low flexibility resin layer more flexible than the A layer. The A layer is composed of a plurality of insulating layers and a conductive layer formed on one face or both faces of the insulating layer. The B layer is composed of one insulating layer and a conductive layer formed on one face or both faces of this insulating layer. The B layer laminated on the A layer may have a plurality of layers. Via plugs Pv and wiring patterns are formed in the A and B layers, and a through plug Pt circuit-connects between the A layer and the B layer. The bending process cuts a plurality of grooves 41, 41, . . . , in the A layer in the area to be given a bending property of a printed wiring board 40 to form a bent part at a part of the printed wiring board 40. The B layer may be one having a glass cloth, or may be one having no glass cloth. The bending process may uniform bias of stress in bending given to the plurality of grooves 41, 41, . . . , by applying solder resist having a bending property to a cutting surface.

FIG. 14 illustrates a structure of electronic apparatus with a printed wiring board having a bending characteristic at a part thereof mounted thereon. Here, an example in which a printed wiring board 30 manufactured in the third embodiment shown in FIG. 10 is employed to small-sized apparatus such as a portable computer.

In FIG. 14, a main body 2 of a portable computer 1 is provided with a display housing 3 through a hinge mechanism so as to rotate freely. The main body 2 is provided with operation units, such as pointing devices and keyboard 4. The display housing 3 is provided with a display device 5 such as an LCD.

The main body 2 is provided with a printed circuit board (motherboard) 6 with a variety of control circuit elements P, which input/output-controls the operation units, such as pointing devices and keyboard 4, and the display device 5, built therein. The printed circuit board 6 is achieved in use of the printed wiring board 30 manufactured through the third embodiment shown in FIGS. 10 and 11 and with the bent areas at two spots formed thereon.

The printed wiring board 30 used for the printed wiring board 6 includes bent areas 7 and 8 in accordance with a mounting space at a substrate housing unit of the main body (housing) 2 to be mounted in the main body (housing) 2. The printed circuit board 6 having the bent part at a part thereof is each applicable to both cases in which the printed circuit board 6 is bent in advance with accordance to the mounting space of the substrate housing unit before it is mounted on the main body (housing) 2, and in which the printed circuit board 6 is bent in a mounting process when it is mounted on the main body (housing) 2.

Using the printed circuit board 6 having the bent part at the forgoing part allows providing small-sized electronic apparatus with effective use of the substrate mounting space in the main body (housing) 2. Applying a printed wiring board with a high yield ratio may provide inexpensive apparatus. Employing a rigid printed wiring board using a glass epoxy base material differing from an FPC structure may provide apparatus which is stabilized electrically.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A printed wiring board comprising:
a first layer which has a plurality of grooves disposed in a bent area, and each length direction of the plurality of grooves intersects to a bending direction; and
a second layer which is disposed on a face of a side opposed to a face with the grooves of the first layer disposed thereon.

2. The printed wiring board according to claim 1, wherein each length direction of the plurality of grooves is almost orthogonal to the bending direction.

3. The printed wiring board according to claim 2, wherein each length direction of the plurality of grooves is arranged to be parallel with one another.

4. The printed wiring board according to claim 3, wherein the second layer includes a plurality of grooves disposed in another bent area.

5. The printed wiring board according to claim 3 further comprising:
an intermediate layer disposed between the first and the second layers; wherein
the second layer of another bent area and the intermediate layer are provided with a plurality of grooves, and
the plurality of grooves disposed in the first layer reach the intermediate layer.

6. The printed wiring board according to claim 1, wherein each length direction of the plurality of grooves is arranged to be parallel with one another and slanted with respect to the bending direction.

7. The printed wiring board according to claim 1, wherein the first layer further includes a plurality of grooves disposed in another bent area.

8. The printed wiring board according to claim 1, wherein the first layer includes a plurality of conductive layers, and at least one conductive layer includes a wiring pattern striding across the bent area.

9. The printed wiring board according to claim 3, wherein each of the grooves has a cross section of a U-or V-shape.

10. The printed wiring board according to claim 9, wherein widths and arrangement intervals of the plurality of grooves are designed so that the first and the second layers are bent in a state in which the grooves are bent toward an inner side.

11. The printed wiring board according to claim 10, wherein the grooves are cut up to a position at which a conductive layer disposed in the second layer is exposed.

12. A bending process method of a printed wiring board for processing a part of a rigid printed wiring board to bend, comprising:
forming a plurality of grooves by cutting an area to bend.

13. The bending process method according to claim 12, wherein the rigid printed wiring board includes laminated first layer and second layer, the plurality of grooves are formed at least one layer of the first and the second layer, and each length direction of the plurality of grooves is almost orthogonal to a bending direction.

14. The bending process method according to claim 12, wherein each length direction of the plurality of grooves is arranged to be almost parallel with one another.

15. The bending process method according to claim 12, wherein each length direction of the plurality of grooves is arranged to be parallel with one another and slanted with respect to the bending direction.

16. The bending process method according to claim 12, wherein each of the grooves has a cross section of a U- or V-shape.

17. Electronic apparatus embedded a circuit board of which the part is bent in a housing body, wherein the circuit board is composed of a rigid printed wiring board with a bent area to bend so that the grooves are bent toward an inner side, or an outer side disposed thereon, by partially cutting an area to be bent by a plurality of groves.

18. The Electronic apparatus according to claim 17, wherein
the rigid printed wiring board includes laminated first layer and second layer,
the plurality of grooves are formed at least one layer of the first and the second layers; and
each length direction of the grooves intersect almost orthogonally to a bending direction.

19. The Electronic apparatus according to claim 17, wherein the circuit board includes a plurality of bent areas, and is bent in the plurality of bent areas to be disposed in the housing.
